(19) United States
(12) Patent Application Publication
(10) Pub. No.: US 2012/0096720 A1
(43) Pub. Date: Apr. 26, 2012

(54) CLIMBING SKINS OFFSET CUTTER

(75) Inventors: Jason Neubauer, Redmond, WA (US); Doug Sanders, Seattle, WA (US)

(73) Assignee: K-2 CORPORATION, Seattle, WA (US)

(21) Appl. No.: 13/271,103

(22) Filed: Oct. 11, 2011

Related U.S. Application Data
(60) Provisional application No. 61/405,613, filed on Oct. 21, 2010.

(51) Int. Cl. B26B 27/00

(52) U.S. Cl. 30/289

(57) ABSTRACT

A climbing skin offset cutter (100, 200) includes a main body (102, 202) defining an arm (104, 204) defining a first running surface (105, 205) configured to slidably engage a lateral edge of a ski, and a second running surface (115, 215) configured to slidably overlie a climbing skin during trimming. A support wall (106, 206) supports a blade (130, 230) that is angled inwardly such that the blade cutting edge is offset from the first running surface by 1 to 6 millimeters. The first running surface positions the blade cutting edge during use, and the second running surface holds the climbing skin against the ski. No portion of the offset cutter is disposed significantly between the ski and the climbing skin inboard from the offset cutting location.

### CROSS-REFERENCE TO RELATED APPLICATION

This application claims the benefit of Provisional Application No. 61/405,613, filed Oct. 21, 2010, the entire disclosure of which is hereby incorporated by reference herein.

### BACKGROUND

For ski touring, adventure skiing, backcountry skiing, cross-country skiing, telemarking, and the like, a skier will often equip skis with accessories to assist in navigating various terrains and conditions. For example, such skiers will often install a traction-providing accessory to skis to assist the skier when climbing slippery inclines. Historically, strips of certain hides were removably attached to skis to help cross-country skier's ease and efficiency when climbing up slopes while not unduly hindering gliding on downhill slopes. These hides, referred to as “climbing skins,” were attached to the underside of the skis with the hide oriented to provide traction in one direction to permit skiers to climb a slope but with relatively low resistance in the opposite direction to allow gliding down the downhill side of a hill.

Modern climbing skins are a plush material with woven fibers that are woven or bent into a single direction. The climbing skins may be made from either man-made or natural fibers, or blends of man-made and natural fibers. The climbing skins are typically releasably attached to the bottom surface of the ski with an adhesive. The climbing skins are usually also attached to the ski with a mechanical mechanism.

It is desired that the climbing skins conform closely to the shape of the base of the ski in order to provide optimal and consistent traction, but it is also desired that the climbing skins do not cover the metal ski edges so that the edges are available for negotiating steep and icy terrain by proceeding sideways up the hill. Therefore, typically the climbing skins are cut to a shape conforming to the shape of the lower surface or base of the ski (typically only for most of the length of the ski) but offset inwardly from the long edges of the ski, typically by about 1 to 6 millimeters, and more typically 2 to 4 millimeters.

The upper (ski-engaging) surface of the climbing skin will generally have an adhesive coating that is effective for releasably fixing the climbing skin to the base of the ski but allows for removal of the climbing skin without leaving undesirable residue on the ski.

In a typical procedure for adapting a climbing skin to a particular ski, the user obtains a climbing skin that is oversized for the particular ski. The climbing skin is first attached to the ski by the adhesive on its upper surface, and a blade is used to trim the climbing skin flush with one lateral edge of the ski. The climbing skin is then peeled away from the ski and carefully repositioned such that the newly cut edge of the climbing skin is positioned approximately twice the desired final distance from the corresponding lateral edge of the ski. The opposite edge of the climbing skin is then trimmed with the blade to be flush with the lateral edge of the ski. Finally, the climbing skin is peeled away from the ski. To use the climbing skin, it is repositioned approximately centered on the ski such that both lateral edges of the ski are uncovered. This process is time-consuming, labor intensive, and susceptible to error, which can damage or ruin the climbing skin. In particular, the step of repositioning the skin on the ski is challenging due to the adhesive interface.

U.S. Patent Application Publication No. 2010/0096838, to McCrank et al., which is hereby incorporated by reference in its entirety, also recognizes this problem and discloses a tool for offset trimming of climbing skins. The device disclosed in McCrank et al. comprises (a) a guide having a narrower first surface (21) that slides along a lateral edge of the ski during trimming, and a larger second surface (22) that contacts and slides along the base of the ski during trimming, and (b) a cutter (23) including a blade holder (28) and a pair of blades (27). As seen most clearly in FIG. 5C and FIG. 7 of McCrank et al., the cutter is mounted on a guide or part (35) that defines the larger second surface and extends a considerable distance over the ski base and under the climbing skin during trimming. Therefore, the guide is positioned between the upper surface of the climbing skin and the base of the ski. The guide will naturally encounter significant resistance as the cutter is manipulated by the user along the edge of the ski. Suitable force must be applied by the user to overcome the resistance caused by the adhesive. The guide sliding between the climbing skin and ski will also interfere with the adhesion of the climbing skin to the ski during trimming, which could result in slippage of the climbing skin, resulting in mis-cutting or other damage to the climbing skin.

There is a need, therefore, for an easier means of trimming climbing skins to be slightly smaller than the ski base shape.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An offset cutter for trimming climbing skins for skis is disclosed which requires less force from the user because it does not require any substantial portion of the cutter to slide between the climbing skin and the ski base during use. The cutter also includes a running surface that holds and presses the climbing skin against the ski during trimming.

In an embodiment, the offset cutter includes a main body that includes (i) an arm defining a first running surface that slidably engages a lateral edge of the ski, (ii) a panel defining a second running surface that overlies the climbing skin during cutting, and (iii) a support wall that connects the arm to the panel. A cutting blade is supported by the support wall at an angle relative to the first and second running surfaces such that an exposed cutting edge portion of the blade is disposed an offset distance inwardly from the first running surface. In an embodiment, the support wall defines a slot that exposes the cutting edge portion of the blade. The blade may be permanently embedded in the support wall.

In an embodiment, the offset cutter is reversible, wherein the main body defines a pair of arms, each providing separate first running surfaces, and the panel is formed as a V-shaped member, also defining two second running surfaces. The blade includes two exposed cutting edge portions that are exposed on opposite sides of the support wall. The offset cutter may be selectively oriented to trim the climbing skin offset from the lateral edge of the ski or offset from a second lateral edge of the ski.

In an embodiment, the offset distance for the cutter is between 1 and 6 millimeters, and the support wall is disposed at an acute angle relative to the first running surface that is between 1 and 10 degrees.

In an embodiment, the offset cutter for trimming a climbing skin for a ski includes a main body comprising (i) a first arm extending distally from a corner of the main body and defining a first edge running surface, and a second arm extending distally from the corner of the main body defining a second edge running surface, (ii) a V-shaped member defining a first panel associated with the first arm and defining a first skin running surface, and a second panel associated with the second arm and defining a second skin running surface, and (iii) a support wall that connects the first and second arms with the V-shaped member, the first wall defining a first slot and a second slot; and also includes a blade comprising one or more parts and fixedly supported by the main body, the blade having a first cutting edge portion exposed in the first slot and a second blade cutting edge portion exposed in the second slot, wherein the first and second blade cutting edge portions are disposed an offset distance inwardly from the first and second edge running surfaces.

In an embodiment, the offset cutter for trimming a climbing skin includes a main body comprising a first running surface configured to slidably engage a lateral edge of a ski, and a second running surface oriented at an angle to the first running surface and configured to slidably engage the outer surface of a climbing skin disposed on a base surface of the ski, the main body further comprising a blade supporting wall; a blade supported by the blade supporting wall, the blade having a cutting edge portion; wherein when the first running surface slidably engages the edge of the ski and the second running surface slidably engages the climbing skin, the cutting edge portion blade is disposed directly over the base of the ski and is disposed inwardly to cuttingly engage the climbing skin.

### DESCRIPTION OF THE DRAWINGS

The foregoing aspects and many of the attendant advantages of this invention will become more readily appreciated as the same become better understood by reference to the following detailed description when taken in conjunction with the accompanying drawings, wherein:

FIG. 1 is a front-left perspective view of a climbing skin offset cutter in accordance with the present invention;

FIG. 2 is a front view of the offset cutter shown in FIG. 1;

FIG. 3 is a left side view of the offset cutter shown in FIG. 1;

FIG. 4 is an environmental view showing the climbing skin offset cutter of FIG. 1 in use;

FIG. 5 is a cross-sectional view taken along a vertical plane at a front edge of the offset cutter blade;

FIG. 6 is a front-left perspective view of a second embodiment of a climbing skin offset cutter in accordance with the present invention; and

FIG. 7 is a left side view of the offset cutter shown in FIG. 6.

### DETAILED DESCRIPTION

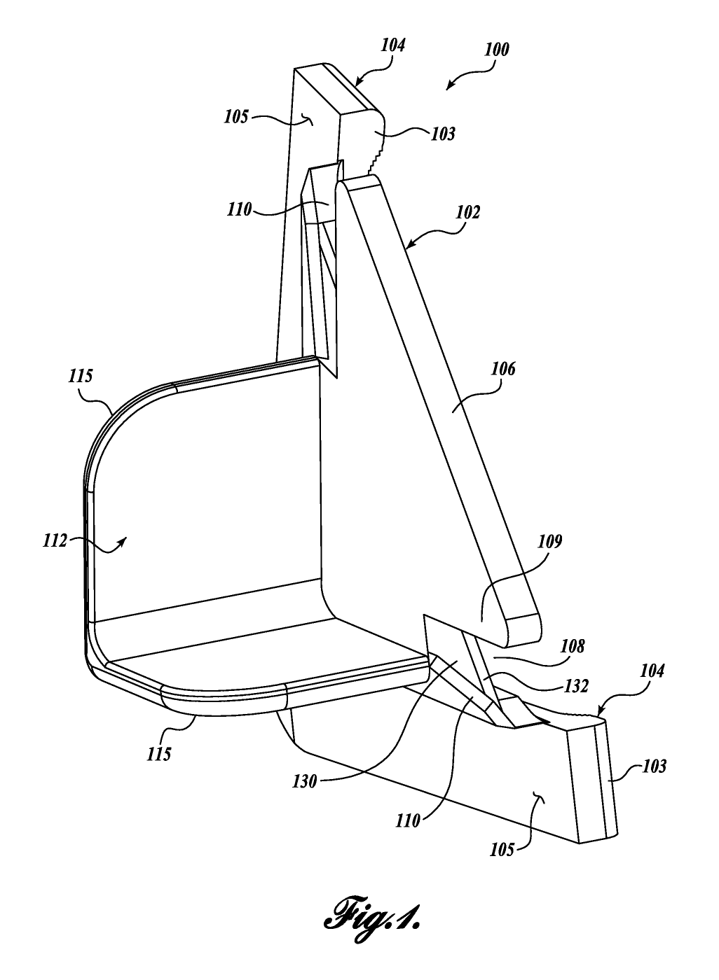

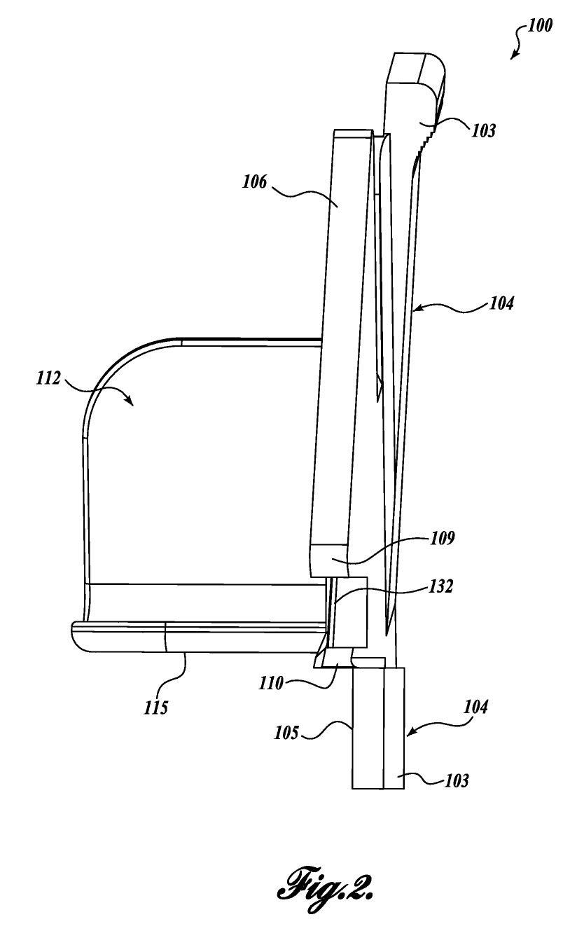

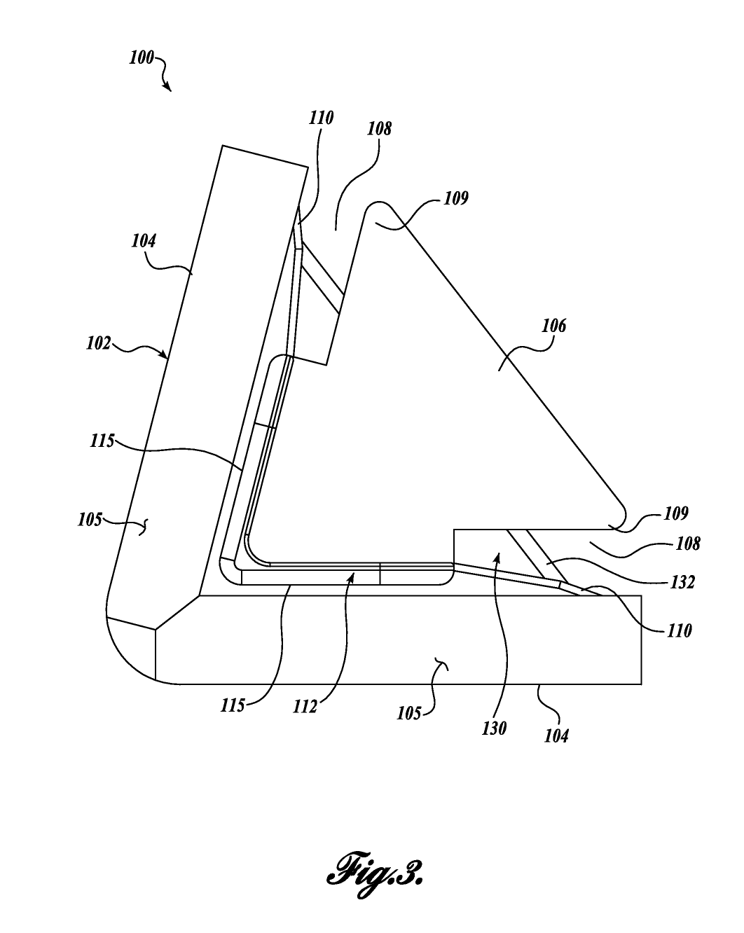

FIG. 1 shows a climbing skin offset cutter 100 in accordance with the present invention. Refer also to FIG. 2, which shows a front view of the offset cutter 100, and to FIG. 3, which shows a left side view of the offset cutter 100. The offset cutter 100 includes a main body 102 that supports a sharp blade 130. In the disclosed and currently preferred embodiment, the blade 130 is permanently fixed to the main body 102. It will be appreciated that an individual user will typically trim the climbing skins once. However, it is contemplated that the blade may alternatively be removably attached to the body. A removable blade may be particularly advantageous for use in a ski shop, for example, where the same tool may be used to trim a larger number of climbing skins. To accommodate a removable blade, the cutter body may be formed in multiple parts defining a retaining recess for the blade, or may be formed unitarily with a suitably shaped slot to releasably receive the blade in a snap-fit, in accordance with methods well known in the art. In a current embodiment, the main body 102 is molded, for example injection molded, from a suitable polymer, with the blade 130 prepositioned in the mold such that it is embedded in the main body 102 during the molding process.

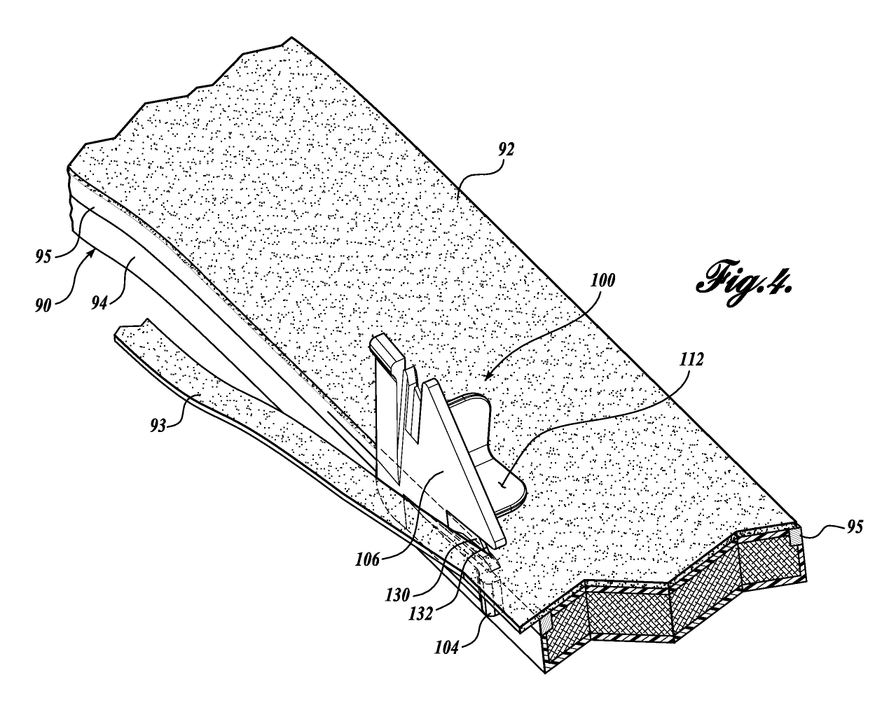

As seen most clearly in FIGS. 1 and 3, the main body 102 includes a pair of first arms 104 that each define a first running surface 105. Each first running surface 105 is configured to slidably engage a lateral edge 94 of the ski 90 (FIG. 4) to guide the offset cutter 100 during use. Optionally, the first arms 104 each also include an ergonomically curved distal portion 103 that may include surface grip features, such as knurls, to facilitate the user pushing the offset cutter 100 along the length of the ski 90.

The main body 102 further includes a support wall 106 that connects to each of the first arms 104. In the currently preferred embodiment, the support wall 106 is angled generally to the left in FIG. 1 relative to the arms 104 such that the support wall 106 extends inwardly with respect to the planes defined by the first running surfaces 105. The purpose of the angled orientation of the support wall 106 is explained below.

The support wall 106 further defines a pair of openings or wide slots 108 adjacent the first running surfaces 105, respectively. Each slot 108 exposes a portion of the blade 130. In particular, the exposed portion of the blade 130 is disposed between an upper portion 109 of the support wall 106 and a lower portion 110 of the support wall 106.

A V-shaped member 112 extends inwardly from the support wall 106. Each leg of the V-shaped member 112 defines an outwardly-facing second running surface 115 that is configured to slide over the bottom or outer surface of the climbing skin 92 (see FIG. 4) to guide the offset cutter 100 during use and to press the climbing skin 92 against the ski 90 during trimming. During use, the upright leg of the V-shaped member 112 also provides a handle or structure that the user can press against to guide the offset cutter 100 along the ski 90.

As seen most clearly in FIGS. 1 and 2, the blade 130 is oriented at an angle with respect to the planes defined by the first running surfaces 105. Therefore, at least a cutting edge portion 132 of the blade 130 (the portion that directly engages the skin 92 during trimming) is disposed inwardly from the first running surfaces 105. In the preferred embodiment, the cutting edge 132 of the blade 130 is disposed between 1 and 6 millimeters inwardly from the first running surfaces 105, and more preferably between 2 and 4 millimeters inwardly from the first running surfaces 105. In the preferred embodiment, the blade 130 is aligned along a plane that is oriented between 1 and 10 degrees from the planes defined by the first running surfaces 105, and more preferably, between 2 and 4 degrees from the planes defined by the first running surfaces 105.

It will be appreciated from the drawings and from the above description that the offset cutter 100 provides two distinct cutting regions defined by the portions of the blade 130 exposed in the two slots 108. This configuration, although not required for the present invention, provides an advantage because it allows the offset cutter 100 to be used to trim climbing skins 92 on either side of the ski 90, moving the offset cutter 100 from the tip end of the ski 90 towards the tail end, e.g., in the direction of the nap on the climbing skin 92. Although it is contemplated that the offset cutter 100 may be operated in the opposite direction (i.e., towards the tip end of the ski), the force required for the trimming operation will be less when moving in the tip-to-tail direction because the second running surface 115 runs along the top or outer surface of the climbing skin 92. The climbing skin 92 is, as discussed above, designed to provide lower resistance in the tip-to-tail direction and greater traction in the tail-to-tip direction.

Although the offset cutter 100 with two distinct cutting regions 108 is currently preferred, it is contemplated that the cutter may alternatively be constructed with a single cutting region with straightforward modifications to the embodiment shown in the FIGURES. It may be desirable to provide a single cutting region offset cutter, for example, to reduce manufacturing costs, in which case it is contemplated that such a cutter may be operated in the tail-to-tip direction. It is also contemplated that an offset cutter in accordance with the present invention may be constructed with a pair of individual single-cutter tools wherein one tool is used for right-side trimming and the other tool is used for left-side trimming.

FIG. 4 shows the offset cutter 100 in use trimming an edge of the climbing skin 92 which is attached to a ski 90. The support wall 106 and blade 130 position the cutting edge 132 of the blade at a precise location inwardly offset from the illustrated lateral edge 94 of the ski 90 when the selected first running surface 105 (not visible) is positioned adjacent the lateral edge 94. The angular orientation of the blade 130 will tend to pull the offset cutter inwardly, providing an inward force during use that urges the first running surface 105 towards the ski lateral edge 94.

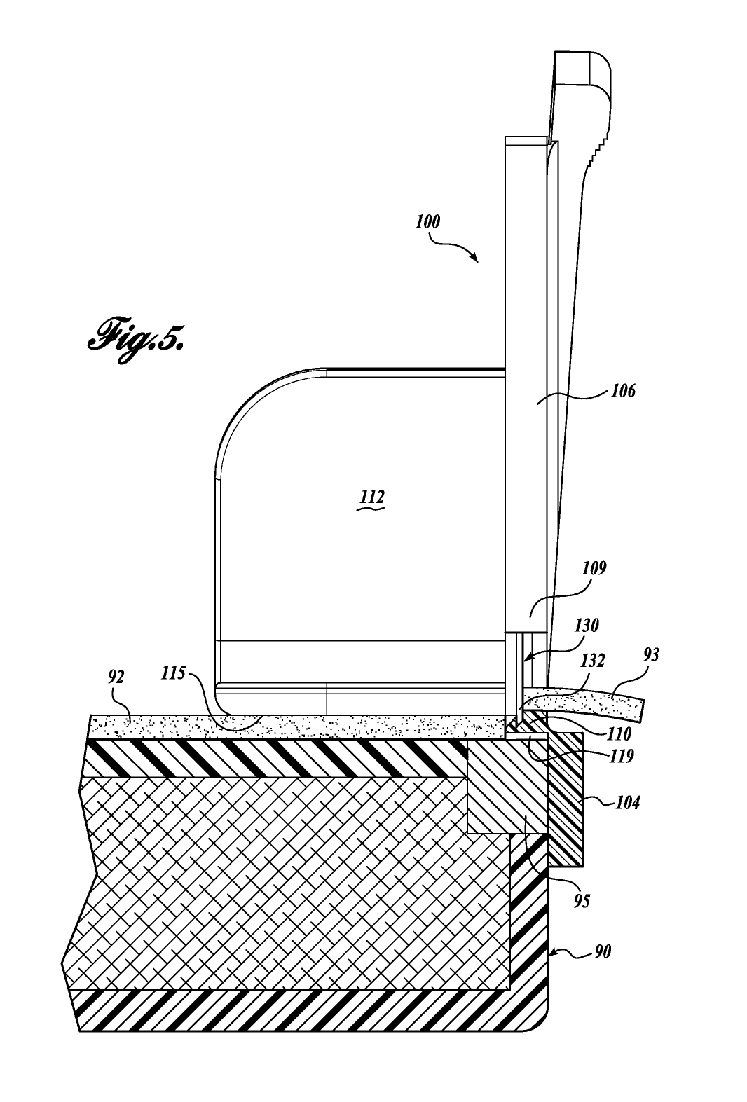

The corresponding second running surface 115 (not visible) of the V-shaped member 112 runs on top of the climbing skin 92, and in particular, is not inserted between the climbing skin 92 and the base of the ski 90. Refer now also to FIG. 5, which is a cross-sectional view taken vertically approximately at the location that the blade 130 cuts the climbing skin 92. The only portion of the offset cutter 100 that is positioned over the base of the ski 90 is the lower portion 110 of the support wall 106, which is positioned substantially outboard from the blade 130. Therefore, the trimmed portion 93 of the cutting skin 92 is lifted away from the ski 90 by the cutting tool 100, exposing the ski edge 95, while the second running surface 115 holds the inward portion of the climbing skin 92 against the ski 90.

It will also be appreciated from FIG. 5 that in this embodiment the second running surface 115 positions the offset cutter 100 in the vertical direction relative to the ski 90. In particular, the lower portion 110 of the support wall 106 in this embodiment is separated by a gap 119 from the base of the ski 90. Therefore, the offset cutter 100 in this embodiment does not directly engage the base portion of the ski 90.

To use the offset cutter 100, a user-selectable one of the first running surfaces 105 is placed against a left or right lateral edge 94 of the ski 90 with the V-shaped member 112 oriented inwardly over the ski. Preferably, but not necessarily, the offset cutter 100 is disposed near the tip end of the ski 90 such that the offset cutter 100 is moved in the tip-to-tail direction. The corresponding second running surface 115 is placed against the climbing skin 92, and the offset cutter 100 is positioned such that the blade 130 engages the climbing skin 92. The user then guides the offset cutter 100 along the length of the ski 90, for example, by pressing on the V-shaped portion 112 and the selected first arm 104. When the selected side of the climbing skin 92 is trimmed, the offset cutter 100 is moved to the other side of the ski 90 and rotated to engage the opposite side of the climbing skin 92. The selected first running surface 105 is positioned adjacent the ski edge and the corresponding second running surface 115 is placed against the climbing skin 92. The user then similarly guides the offset cutter 100 to trim the opposite side of the climbing skin 92.

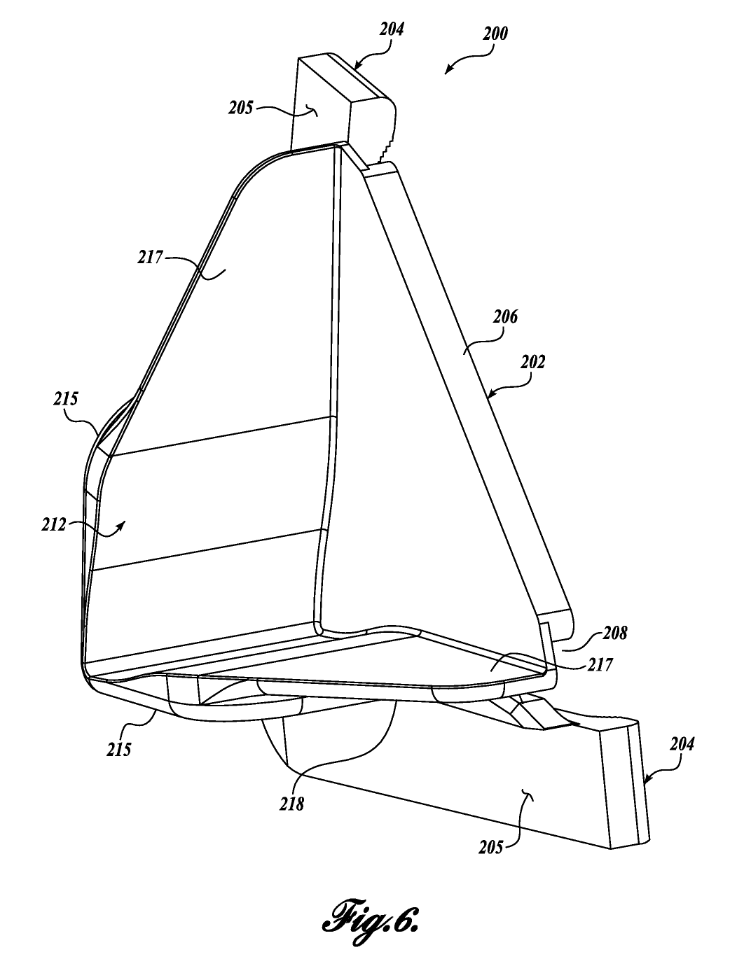

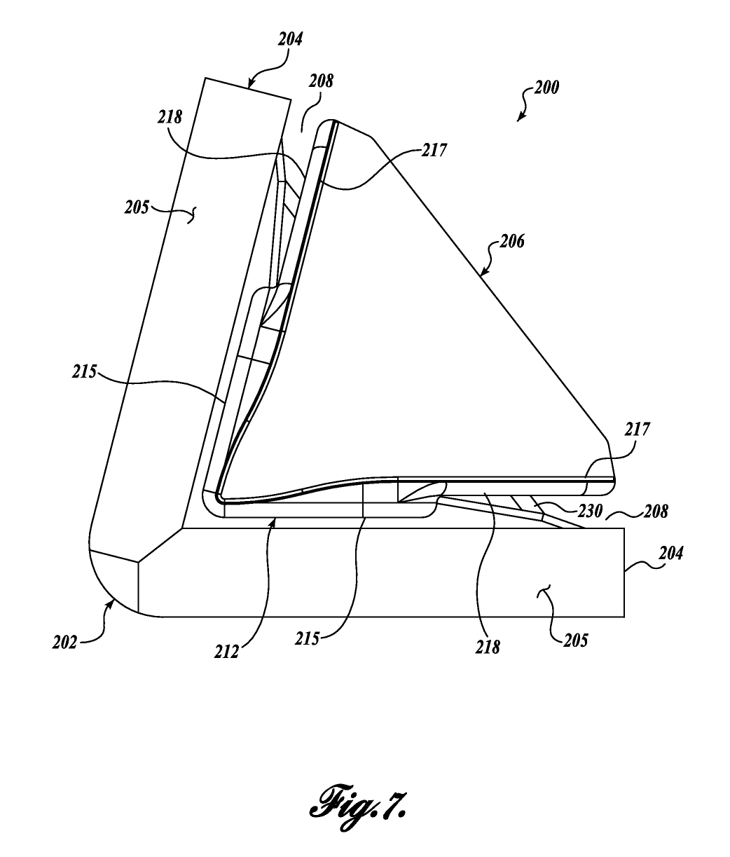

A second embodiment of an offset cutter 200 in accordance with the present invention is shown in FIG. 6, which is a perspective view, and in FIG. 7, which is a left side view. The offset cutter 200 is similar to the offset cutter 100 described above. Aspects of this second embodiment that are substantially similar to the corresponding aspects of offset cutter 100 will not be described in detail so as to avoid repetition. The offset cutter 200 includes a main body 202 with a pair of arms 204 defining corresponding first running surfaces 205. An inwardly angled support wall 206 defines openings or slots 208 that expose cutting edge portions of a blade 230.

An inwardly extending V-shaped member 212 in this embodiment is larger than the V-shaped member 112 in the first embodiment. In particular, the V-shaped member 212 defines a pair of second running surfaces 215 that are configured to overlie the climbing skin 92 during use, as described above. In this embodiment, the V-shaped members include oppositely disposed contoured portions 217 that extend generally to the distal end of the support wall 206. The contoured portions 217 taper distally. As seen most clearly in FIG. 7, the contoured portions 217 define a lower surface 218 that is shaped such that it is above and spaced slightly away from the climbing skin 92 during trimming. The larger and contoured V-shaped member 212 has been found to prevent the climbing skin 92 from lifting away from the ski during trimming, but does not slide along the climbing skin, and therefore does not produce any significant drag during trimming. Moreover, the contoured portions 217 facilitate trimming the climbing skin 92 in the heel-to-toe direction by preventing the napped material from bending or coming over the top of the V-shaped member.

While illustrative embodiments have been illustrated and described, it will be appreciated that various changes can be made therein without departing from the spirit and scope of the invention.

The embodiments of the invention in which an exclusive property or privilege is claimed are defined as follows:

1. An offset cutter for trimming a climbing skin to fit a ski having a base and a lateral edge, the offset cutter comprising:
a main body comprising (i) an arm defining a first running surface that slidably engages the lateral edge of the ski during use, (ii) a panel defining a second running surface transverse to the first running surface, and (iii) a support wall that connects the arm to the panel; and
a blade fixedly supported by the support wall at an acute angle relative to the first running surface, the blade having an exposed cutting edge portion;
wherein the exposed cutting edge portion of the blade is disposed an offset distance inwardly from the first running surface.

2. The offset cutter of claim 1, wherein the second running surface does not directly engage the base of the ski during use.

3. The offset cutter of claim 1, wherein the support wall includes a slot disposed between an upper portion of the support wall and a lower portion of the support wall, and wherein the cutting edge portion of the blade is exposed within the slot.

4. The offset cutter of claim 1, wherein the main body comprises two first running surfaces and two second running surfaces, and further wherein the blade includes two exposed cutting edge portions such that the offset cutter may be selectively oriented to trim the climbing skin offset from the lateral edge of the ski or offset from a second lateral edge of the ski.

5. The offset cutter of claim 1, wherein the offset distance is between 1 and 6 millimeters.

6. The offset cutter of claim 1, wherein the acute angle is between 1 and 10 degrees.

7. The offset cutter of claim 1, wherein the blade is permanently embedded in the main body.

8. The offset cutter of claim 1, wherein the arm further comprises a curved distal portion to facilitate pushing the offset cutter.

9. An offset cutter for trimming a climbing skin for a ski, the offset cutter comprising:
a main body comprising (i) a first arm extending distally from a corner of the main body and defining a first edge running surface, and a second arm extending distally from the corner of the main body defining a second edge running surface, (ii) a V-shaped member defining a first panel associated with the first arm and defining a first skin running surface, and a second panel associated with the second arm and defining a second skin running surface, and (iii) a support wall that connects the first and second arms with the V-shaped member, the support wall defining a first slot and a second slot; and
a blade comprising one or more parts and fixedly supported by the main body, the blade having a first cutting edge portion exposed in the first slot and a second cutting edge portion exposed in the second slot, wherein the first and second cutting edge portions are disposed an offset distance inwardly from the first and second edge running surfaces, respectively.

10. The offset cutter of claim 9, wherein the first and second skin running surfaces do not directly contact a base of the ski during use.

11. The offset cutter of claim 9, wherein the offset distance is between 1 and 6 millimeters.

12. The offset cutter of claim 9, the blade is permanently embedded in the main body.

13. The offset cutter of claim 9, wherein the first arm further comprises a curved distal portion to facilitate pushing the offset cutter.

14. A climbing skin offset cutter for trimming climbing skins for a ski, the offset cutter comprising:
a main body comprising a first running surface configured to slidably engage a lateral edge of a ski, and a second running surface oriented at an angle to the first running surface and configured to slidably engage an outer surface of a climbing skin disposed on a base of the ski, the main body further comprising a blade supporting wall; and
a blade supported by the blade supporting wall, the blade having a cutting edge portion;
wherein when the first running surface slidably engages the lateral edge of the ski and the second running surface slidably engages the climbing skin, the cutting edge portion of the blade is disposed directly over the base of the ski and is offset inwardly from the lateral edge to cuttingly engage the climbing skin.

15. The climbing skin offset cutter of claim 14, wherein no portion of the offset cutter directly engages the base of the ski during use.

16. The climbing skin offset cutter of claim 14, wherein the blade supporting wall defines a slot disposed between an upper portion of the blade supporting wall and a lower portion of the blade supporting wall, and wherein the cutting edge portion of the blade is exposed within the slot.

17. The climbing skin offset cutter of claim 14, wherein the main body comprises a plurality of first and second running surfaces such that the offset cutter may be selectively oriented to cut the climbing skin with any selected one of the plurality of first running surfaces slidably engaging the edge of the ski and a corresponding one of the plurality of second running surfaces slidably engaging the outer surface of the climbing skin.

18. The climbing skin offset cutter of claim 14, wherein during use the blade is angled inwardly such that the blade engages the climbing skin at a cutting angle with respect to the lateral edge of the ski, wherein the cutting angle is between 1 and 10 degrees.

19. The climbing skin offset cutter of claim 18, wherein the cutting angle is between 2 and 4 degrees.

20. The climbing skin offset cutter of claim 14, wherein the second running surface includes a distal portion that is curved away from the climbing skin during use.
